(19) United States
(12) Patent Application Publication
(10) Pub. No.: US 2010/0298037 A1
(43) Pub. Date: Nov. 25, 2010

(54) Pedal-Operated Threshing Machine

(75) Inventors: Tyler Moser, Bridgewater, NJ (US); James Wittel, Bridgewater, NJ (US); Phyllis Schlafly, Far Hills, NJ (US); David Schmidt, Mountainside, NJ (US); Bethany Shotyk, Piscataway, NJ (US); Kenneth Shotyk, Piscataway, NJ (US); Marissa Scalzo, Kenilworth, NJ (US); Gina Scalzo, Kenilworth, NJ (US); Adrianna Scalzo, Kenilworth, NJ (US)

Correspondence Address: Sunstein Kann Murphy & Timbers LLP, 125 SUMMER STREET, BOSTON, MA, 02110-1618, UNITED STATES, 617-443-9292, 617-443-0004, PATENTS@SUNSTEINLAW.COM

(73) Assignee: TEEN TECHNOLOGY A NJ NONPROFIT CORPORATION, Bridgewater, NJ (US)

(21) Appl. No.: 12/777,949

(22) Filed: May 11, 2010

(51) Int. Cl. A01F 12/18; A01F 7/00; A01F 12/32

(52) U.S. Cl. 460/59; 460/149; 460/101

(57) ABSTRACT

A pedal-driven machine and methods for processing grain using the physical exertions of a single individual. The single individual feeds a panicle of grain into a thresher, drives the thresher to thresh the grain, winnows the threshed grain with a winnower, and collects the threshed grain, all concurrently. The panicle may be withdrawn from the thresher after being threshed without the panicle having passed entirely through the thresher. The machine that enables the foregoing processing by a single individual has a pedaling mechanism for driving both the thresher and the winnower via a single drive member.

### TECHNICAL FIELD

The present invention relates to an apparatus and methods for threshing and winnowing a range of edible grains using solely the power provided by human exertion.

### BACKGROUND OF THE INVENTION

Human cultivation of cereal grains can be traced back nearly 10,000 years and likely began by cultivation of species that humans had been gathering in the wild prior to the inception of agriculture. Thus, from time immemorial, people have dealt with the issue of removing the edible portion of a grain from the inedible chaff.

In order to render cereal grains edible, at least two steps must be implemented: the edible part of the grain must be loosened from its surrounding inedible chaff, and, then, the chaff must be physically separated from the edible grain. The loosening step is referred to as threshing, while the physical separation of edible grain from chaff is referred to as winnowing. The terms “threshing” and “winnowing” will have the aforesaid meaning when used herein, and in any appended claims, unless the context requires otherwise. The term “cleaning,” may be synonymous with “winnowing,” or may denote additional processing following winnowing.

Archeological evidence suggests that tools have been used for the threshing process for at least 8,000 years. Throughout most of this time, the threshing process has either been a joint effort requiring several people to work together (e.g. at least one person threshing, one person winnowing, one person cleaning), or has been a weighty undertaking of a single person first threshing, then moving on to winnowing, then moving on to cleaning, and so on. In modern times, industrial-grade automated threshers have been developed that can perform all of these steps quickly and concurrently, but such machines are expensive, and require gas or electricity to run. These machines also require expensive maintenance and replacement parts. No machine exists allowing a single individual to perform all of the steps of processing harvested grain concurrently using the physical exertions of the individual.

### SUMMARY OF THE INVENTION

A first embodiment of the present invention is a method of processing grain using the physical exertions of a single individual. The method includes a single individual feeding a panicle of grain into a thresher, driving the thresher to thresh the grain, winnowing the threshed grain with a winnower, and collecting the threshed grain, with all of these steps being performed concurrently. The thresher and the winnower are both driven by the physical exertions of the single individual. The panicle may be withdrawn from the thresher after being threshed without the panicle having passed entirely through the thresher.

A second embodiment of the present invention is a pedal-driven machine for processing grain. The machine includes a thresher for separating panicle material leaving threshed grain, a winnower for separating chaff from the threshed grain, a pedaling mechanism for driving the thresher and the winnower, and a single drive member coupling the pedaling mechanism to the thresher and the winnower. The winnower may include a squirrel cage fan. The winnower also may include a grate, disposed in a path of upwardly flowing air, for expelling chaff and collecting grain. A directional flow of winnowing air and an output of the thresher may be countercurrent to each other. The thresher may include a concave and a drum disposed within the concave. Threshing members may be disposed on the interior of the concave an on the exterior of the drum. In certain embodiments the threshing members may be pegs or brushes. The concave may be disposed relative to the drum in such a manner as not to admit the entire panicle. In certain embodiments a gap between the threshing members of the concave and the threshing members of the drum is adjustable. Alternatively, or in addition, an annular space between the concave and the drum is adjustable. In certain embodiments the pedaling mechanism includes pedals and a wheel, and the pedals and the wheel rotate around a common axis. Alternatively, or in addition, the pedals are coupled to the wheel by a ratcheted hub. The method of the first embodiment also may be performed with a machine according to the second embodiment of the invention.

### BRIEF DESCRIPTION OF THE DRAWINGS

The foregoing features of the invention will be more readily understood by reference to the following detailed description taken with the accompanying drawings:

FIG. 1 is a perspective view of a machine for processing grain according to an embodiment of the present invention.

FIG. 2 is a perspective view of a thresher for use in the machine of FIG. 2.

FIG. 3 is a perspective view of a winnower for use in the machine of FIG. 2.

FIG. 4 is a side view of a machine for processing grain according to an embodiment of the present invention.

FIG. 5 is a front view of the machine of FIG. 5.

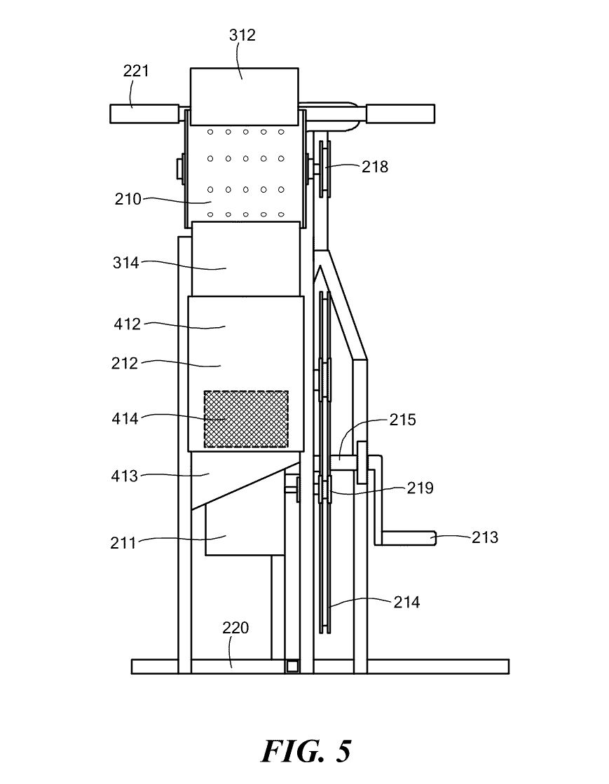

FIG. 6 is a perspective view of a machine for processing grain according to an embodiment of the present invention.

FIG. 7 is a flow chart of a process of processing grain according to an embodiment of the present invention.

FIG. 8 is a cross sectional view of a thresher for use in a machine according to an embodiment of the present invention.

### DETAILED DESCRIPTION OF EMBODIMENTS OF THE INVENTION

Definitions:

The following terms, as used herein and in any appended claims, shall have the meanings indicated, unless the context requires otherwise.

A 37 drive member” shall denote a unitary coupling for transferring power from one mechanical component to another and may include a belt, a chain, or another linkage.

In accordance with embodiments of the present invention, a system and methods are described that may advantageously enable a single operator to perform all the steps involved in processing harvested plant material into edible grain ready to be processed (e.g. cooked, soaked, etc.) for consumption.

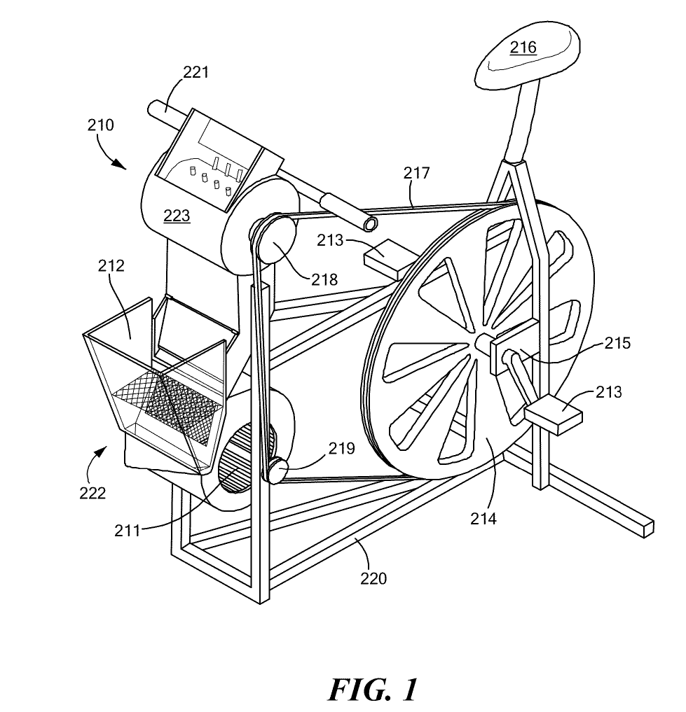

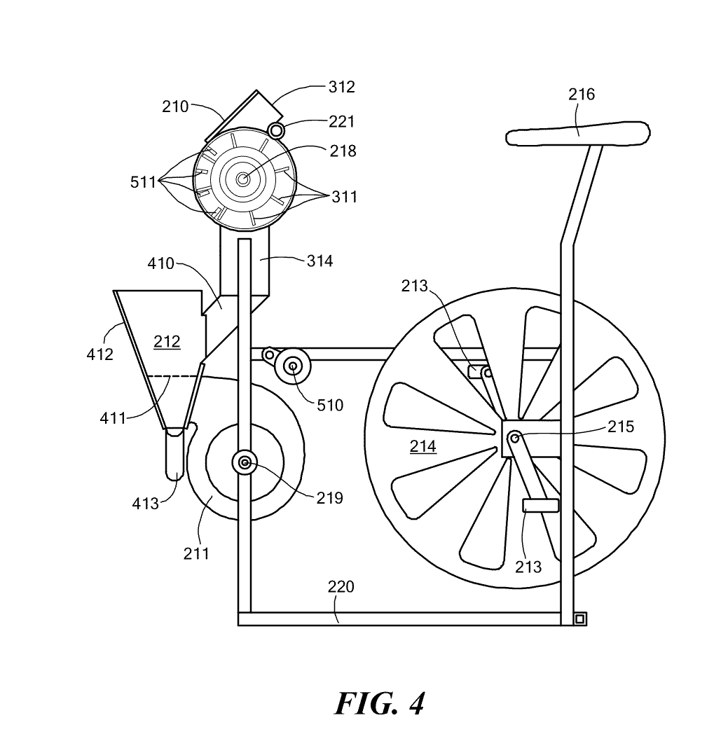

A machine for processing grain according to an embodiment of the present invention is now described with reference to FIG. 1. A thresher, designated generally by numeral 210, is mounted above a winnower, designated generally by numeral 222, having a fan 211 operatively coupled to a winnowing area 212 so that when grain (not shown) is threshed in the thresher 210, the threshed grain is directed into the winnowing area 212 by the force of gravity, where the threshed grain is winnowed using the fan 211. The thresher 210 may be implemented as a “drum and concave” (or, equivalently, “cylinder and concave”) as the terms arc understood in the threshing arts. According to one embodiment, the fan 211 may be implemented as a squirrel cage fan. Both the fan 211 and the thresher 210 are driven by a single drive member 217. The drive member is preferably a flexible member, such as a belt. This may be accomplished by operatively coupling the drive member 217 to pulleys 218 and 219. As shown in FIG. 4, a third pulley 510 may be included to alter the angles and tensions with which the drive member 217 engages the pulleys 218 and 219. (The drive member 217 is omitted from FIG. 4 for the sake of clarity.) In certain embodiments, thresher rotation speeds of 600 rpm are desirable and may be realized from the pedal-power of a single individual in accordance with embodiments of the present invention. In some embodiments, surgical tubing has been employed as the single drive member, while in other embodiments flexible belts have been used.

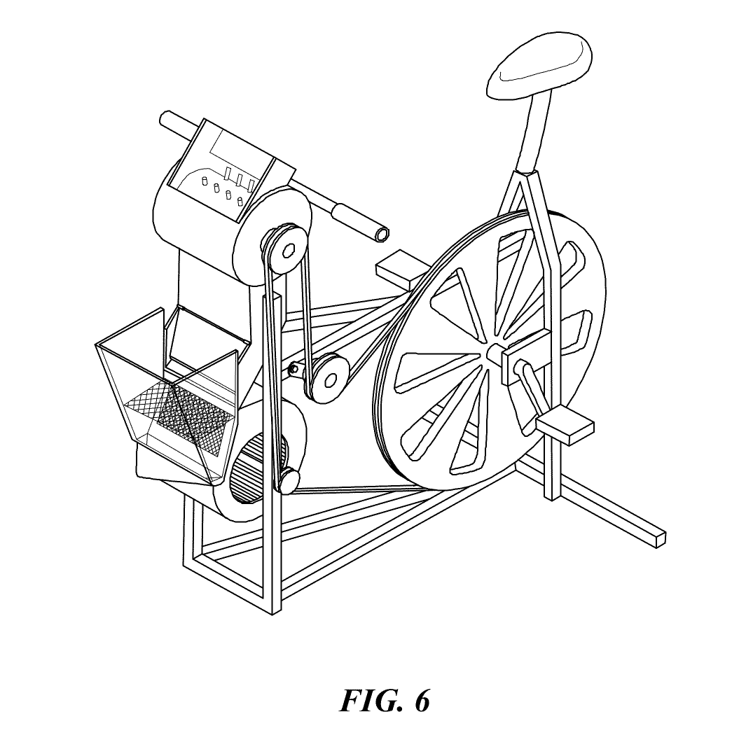

In an embodiment employing the third pulley 510, the drive member 217 is disposed on the underside of the third pulley 510 and the drive member 217 is more tightly engaged to pulley 218. Such an arrangement is shown in FIG. 6. Rotation of pulley 218 causes an interior drum of the thresher 210 to rotate accordingly, while rotation of pulley 219 operates the fan 211 in a similar fashion. The drive member 217 itself is driven by a drive wheel 214. The drive wheel 214 is driven by a pair of pedals 213 which are operated by a human operator who may sit on a saddle 216 during operation. The human operator also may grasp a handle bar 221, mounted on the thresher 210, for balance. The pedals 213 may advantageously be coupled to the drive wheel 214 by a ratcheted hub 215 which allows the drive wheel 214 to continue to rotate while the pedals 213 are stationary. In embodiments of the present invention, the pedals 213 and the drive wheel 214 rotate around a common axis. Pedal-driven systems commonly are operated differently. A common configuration includes the pedals being configured to drive a crank or chainring that rotates around the same axis as the pedals, such that chain or belt drives a wheel larger than the crank. The wheel thus rotates around a different axis than the pedals. Such an arrangement, however, is more expensive because it requires more parts, it is more complicated to manufacture, and is harder to maintain when parts need to be replaced. A frame 220 provides the support structure allowing the parts of the machine to be mounted in the configuration just described.

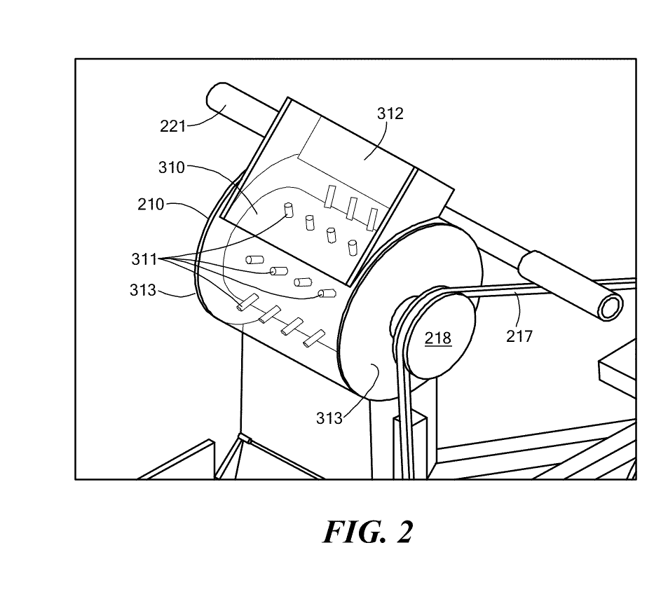

The configuration and operation of the thresher 210 is now described in greater detail with reference to FIG. 2. A rotating drum 310 (or “cylinder”) is disposed inside of a concave 223 (see FIG. 1; concave is transparent in FIG. 2 to show the interior of the thresher 210). The rotating drum rotates according to the action of the single drive member 217 turning pulley 218. The rotating drum 310 has a plurality of threshing members 311, in this embodiment, pegs, disposed on the exterior of the drum. In alternate embodiments, other threshing members may be used, such as brushes, rasp bars, paddles, knife edges, hooks, or other threshing members known in the art. A pair of caps 313 close the ends of the thresher 210. An intake port 312 allows the human operator to introduce grain panicles into the interior of the thresher 210 where the grain is threshed by the combined action of rotating threshing members 311 on the exterior surface of the rotating drum 310 and stationary threshing members 511 (see FIG. 4) on the interior surface of the concave. The threshed grain then exits the thresher 210 via an exit port 314.

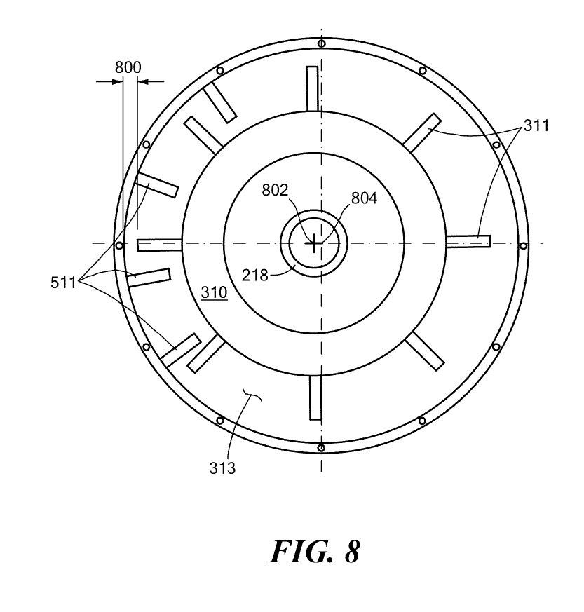

In accordance with one embodiment of the present invention, a gap 800 between (1) threshing members on the exterior of rotating drum and (2) the interior surface of the concave is adjustable. Adjusting the size of this gap may advantageously allow for successful processing of different varieties of grain having different sizes and physical properties, or for successful processing of different sizes of a single variety of grain. One manner of implementing such an adjustment is shown in FIG. 8. The rotating drum 310 is situated such that axis of rotation 802 of the drum is non-collinear with (but parallel to) central axis 804 of the concave 223. The gap may be adjusted by relocating the axis of rotating of the rotating drum 310, for example through rotation of the caps 310.

The rotating drum 310 and the concave are preferably of a size and shape so as to not admit the entire panicle into the threshing area. The single individual human operator (not shown) can advantageously introduce one or more panicles into the thresher 210 while the thresher 210 and fan 211 are both being operated due to the single individual human operator engaging the pedals 213. The operator continues to hold the panicles by their stems while the grain is being threshed from the panicles. Improved threshing performance may be achieved by rotating the panicles during threshing. Moving the panicles forward and backward within the thresher during threshing also may improve threshing performance. When the current panicles have been threshed, the operator withdraws the panicles through the intake port 312, discards the threshed panicles, and may repeat the process with at least one of the remaining panicles that has not yet been threshed. This “hold-on feed” design, wherein the stem and much of the inedible panicle material does not pass through the thresher along with the threshed grain, assures that the operator will push the panicle forward and backward at least once upon inserting and upon withdrawing the panicle, leading to improved threshing performance relative to “feed-through” designs, and if desired the operator may choose to move the panicle forward and backward more than once during threshing for a more complete threshing.

Unlike many “feed-through” designs, no conveyors or racks are needed to remove the stalks, and because extraneous plant material has not been crushed and mixed with the seeds, the subsequent winnowing and cleaning is more efficient. Winnowing and cleaning, which are essential parts of processing grain just as threshing is, are at least as tedious as threshing when done with the primitive methods and equipment that are standard in many parts of the world. Because the panicles are not fed through, a greater portion of the larger contaminants, such as stones, and the bulky inedible stems, are eliminated at the outset.

Improvements to threshing designs have tended to be associated with increased automation. Use of “feed-through” designs is one example. Surprisingly, however, for providing increased efficiency to the overall procedure of processing grain by an individual with very limited resources, embodiments of the present invention show that less can be more. The level of automation provided by embodiments of the present invention, which employ a “hold-on feed” design, far exceeds the techniques currently in use (commonly mortar and pestle threshing followed by winnowing with baskets). Accordingly, the amount of labor may advantageously be greatly reduced. At the same time, by explicitly maintaining a “hold-on feed” design, mechanical and economic efficiency may actually be improved. Fewer and simpler parts can be used; more of the human operator's energy can be used for threshing and cleaning grain, rather than processing waste material; and the cleaning process is more thorough.

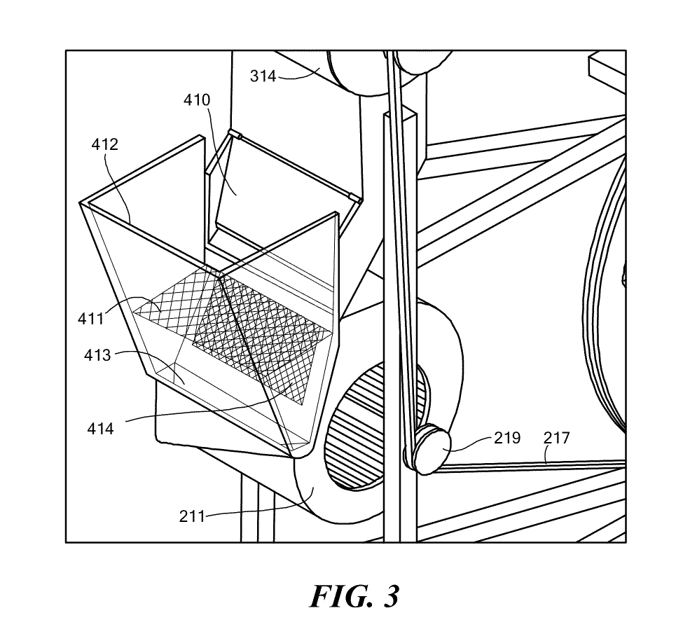

The configuration and operation of the winnower is now described in greater detail with reference to FIG. 3. Threshed grain that has fallen through the exit port 314 is directed into the winnowing area 212 by a thresher output ramp 410. The threshed grain continues to travel downward from the thresher output ramp 410 onto a grate 411. The fan 211 is driven by the action of the single drive member 217 turning pulley 219. Airflow from the fan 211 passes through a fan exhaust grate 414 and upward through the grate 411, creating a fluidized bed (countercurrent) of upwardly flowing air against the downwardly falling threshed grain. The countercurrent of upwardly flowing air causes lighter portions of the threshed grain (i.e. chaff, waste material) to be expelled upward away from the grain, while the heavier portions of the threshed grain (i.e. the desired edible grains) are not blown upward due to their greater weight. The grain is thus cleaned. The cleaned grain is retained in the winnowing area by a retaining wall 412, while the chaff is expelled over the retaining wall 412. The cleaned grain then falls through holes in the grate 411 into a collection area 413 where the grain is collected. The fan exhaust grate 414 allows air to exit the fan 211, but hinders the cleaned grain from falling into the fan 211 itself.

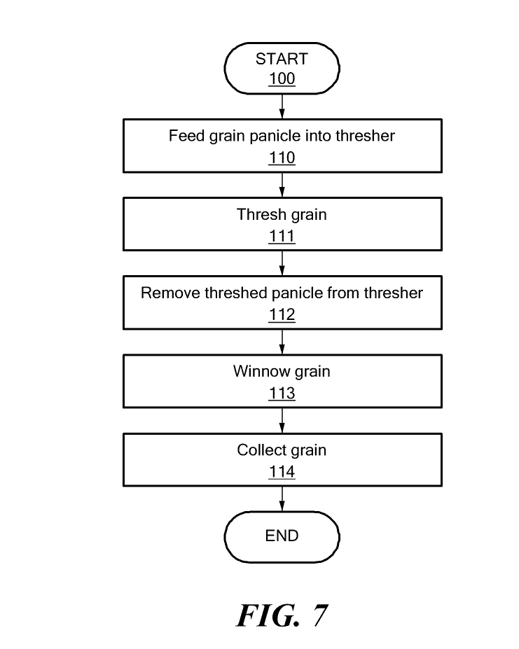

Steps of a method of processing grain according to an embodiment of the present invention are now described with reference to FIG. 7. The process begins at step 100. At step 110 a single individual human operator feeds at least one grain panicle into a thresher. The thresher is driven by the physical exertions of the operator. At step 111 the thresher threshes the grain. At step 112 the operator removes the threshed panicle from the thresher. At this point the human operator can take the next unthreshed panicle and repeat steps 110, 111 and 112 at the same time as the process proceeds to step 113. At step 113, the threshed grain is winnowed by a winnower. The winnower is driven, concurrently with the thresher, by the physical exertions of the single individual human operator. Winnowed grain is then collected in step 114, at which point the process, relative to the grain that has been collected, stops. In practice, the operator will perform steps 110, 111 and 112 repeatedly, so that grain is being threshed, winnowed, and collected on an ongoing basis for as long as the operator continues to operate.

The described embodiments of the invention are intended to be merely exemplary and numerous variations and modifications will be apparent to those skilled in the art. All such variations and modifications are intended to be within the scope of the present invention as defined in the appended claims.

We claim:

1. A method of processing grain using the physical exertions of a single individual, the method comprising:
feeding a panicle of grain into a thresher, wherein feeding is performed by the single individual;
threshing the grain with the thresher, wherein the thresher is driven by the physical exertions of the single individual;
winnowing the threshed grain with a winnower, wherein the winnower is driven by the physical exertion of the single individual; and
collecting the threshed grain;
wherein at least the steps of threshing, winnowing and collecting are performed concurrently.

2. The method of claim 1, further comprising withdrawing the panicle from the thresher without the panicle having passed entirely through the thresher.

3. A pedal-driven machine for processing grain, the machine comprising:
a thresher for separating panicle material leaving threshed grain;
a winnower for separating chaff from the threshed grain;
a pedaling mechanism for driving the thresher and the winnower, the pedaling mechanism including pedals; and
a single drive member coupling the pedaling mechanism to the thresher and the winnower.

4. The machine of claim 3, wherein the winnower comprises a squirrel cage fan.

5. The machine of claim 3, wherein the winnower further comprises a grate, disposed in a path of upwardly flowing air, for expelling chaff and collecting grain.

6. The machine of claim 3, wherein the thresher comprises a concave and a drum disposed within the concave.

7. The machine of claim 6, wherein the concave is disposed relative to the drum in such a manner as not to admit the entire panicle.

8. The machine of claim 6, further comprising:
threshing members disposed on the interior of the concave; and
threshing members disposed on the exterior of the drum.

9. The machine of claim 8, wherein the threshing members are pegs.

10. The machine of claim 8, wherein the threshing members are brushes.

11. The machine of claim 8, wherein a gap between the threshing members of the concave and the threshing members of the drum is adjustable.

12. The machine of claim 8, wherein an annular space between the concave and the drum is adjustable.

13. The machine of claim 3, wherein a directional flow of winnowing air and an output of the thresher are countercurrent to each other.

14. The machine of claim 3, wherein the pedaling mechanism comprises pedals and a wheel, wherein the pedals and the wheel rotate around a common axis.

15. The machine of claim 14, wherein the pedals are coupled to the wheel by a ratcheted hub.

16. The method of claim 1 performed with the machine of claim 3.

17. The method of claim 1 performed with the machine of claim 4.

18. The method of claim 1 performed with the machine of claim 5.
